(19) United States
(12) Patent Application Publication
(10) Pub. No.: US 2019/0101067 A1
(43) Pub. Date: Apr. 4, 2019

(54) A METHOD AND A SYSTEM FOR DETERMINING THE SPECIFIC GAS CONSTANT AND THE STOICHIOMETRIC AIR FUEL RATIO OF A FUEL GAS FOR A GAS ENGINE

(71) Applicant: Scania CV AB, Södertälje (SE)

(72) Inventor: Mårten Wallengren, Tullinge (SE)

(73) Assignee: Scania CV AB, Södertälje (SE)

(21) Appl. No.: 16/085,967

(22) PCT Filed: Mar. 22, 2017
(86) PCT No.: PCT/SE2017/050274

§ 371 Date: Sep. 17, 2018

(30) Foreign Application Priority Data
Mar. 23, 2016 (SE) 1650387-2

(51) Int. Cl. F02D 19/02; F02D 41/00; F02D 41/14; F02D 41/18

(52) U.S. Cl. CPC F02D 19/022; F02D 41/0027; F02D 41/1454; F02D 2200/0612; F02D 2200/0406; F02D 2200/0414; F02D 41/18

(57) ABSTRACT

The present invention relates to a method for determining the specific gas constant and the stoichiometric air fuel ratio of a fuel gas for a gas engine. The method comprises keeping the pressure essentially constant in an inlet manifold of the gas engine, so that the pressure is not varying more than a pre-determined threshold. A first λ value is determined downstream the gas engine. The time period of gas injection into the inlet manifold is then changed. A second λ value downstream the gas engine is determined. The specific gas constant and the stoichiometric air fuel ratio of the fuel gas is then determined based on the determined first and second λ value. The present invention also relates to a system for determining the specific gas constant and the stoichiometric air fuel ratio of a fuel gas for a gas engine, a vehicle, and a computer program product.

### CROSS-REFERENCE TO RELATED APPLICATION(S)

This application is a National Stage Application (filed under 35 § U.S.C. 371) of PCT/SE2017/050274, filed Mar. 22, 2017 of the same title, which, in turn claims priority to Swedish Application No. 1650387-2 filed Mar. 23, 2016 of the same title; the contents of each of which are hereby incorporated by reference.

### FIELD OF THE INVENTION

The present invention relates to a method and a system for determining the specific gas constant and the stoichiometric air fuel ratio of a fuel gas for a gas engine. The present relation also relates to vehicle, to a computer program product for determining the specific gas constant and the stoichiometric air fuel ratio of a fuel gas for a gas engine.

### BACKGROUND OF THE INVENTION

The exhaust aftertreatment of a spark ignited engine running stoichiometric consists often of a three-way catalytic converter in the exhaust system. A three-way catalytic converter must be in chemical balance to be able to reduce nitrogen-oxides emissions and oxidize carbon-monoxide and hydrocarbon emissions. A modern engine management system, EMS, adapts to different fuel qualities by adjusting the air-fuel ratio, AFR, until a so-called stoichiometric ratio could be measured. This is usually done by means of a so-called lambda sensor situated in the exhaust pipe relatively close to the engine. The lambda sensor measures the ratio of actual AFR to stoichiometric AFR. This ration is usually denoted λ. The EMS then controls the fuel injection by adding or reducing the fuel in relation to the air going in to the engine. This is done by a control algorithm called lambda controller.

For petrol as the fuel this works very well and can compensate for different energy contents in the fuel. It also compensates for if some components like fuel injectors, air mass meters or other components involved in calculating air or fuel, are not nominal to their specification. The value of the lambda controller is then saved as an adaptation in the flash memory of an electronic control unit, ECU. This means that the value of the lambda controller can be used next time engine is started. When fuel is stable and all components are functioning properly the adjustments made by the lambda controller are relatively small.

For gaseous fuels a similar control is used.

Problems relating to different fuel qualities of petrol are basically related to different evaporation properties of the petrol. Functions of the EMS relating to different evaporation properties are of no need for gaseous fuels since gaseous fuels do not need to be evaporated.

### SUMMARY OF THE INVENTION

Whereas the energy content of petrol usually only differs by ±1-2 MJ/kg, the energy content of gaseous fuel can differ by around ±5 MJ/kg. Whereas the density of petrol usually only differs with by a percent, the density of gaseous fuels can differ by up to 20%. As a result, the stoichiometric AFR of gaseous fuels can differ considerably. As an example, methane has a stoichiometric AFR of 17.2, while some natural gas on the market has a stoichiometric AFR of 13.1. As a further result, the specific gas constant can be different. While methane has a specific gas constant of around 520 in the international system of units, SI-units, said natural gas on the market has a specific gas constant of around 450 in SI-units.

The solution of using a similar EMS for gaseous fuels as for petrol, i.e. using basically the lambda controller for adjusting differences between different gases, has some drawbacks. The difference between different gases can be so large that it can be difficult to manage the adjustments between the limits of the lambda controller.

The idea of having the standard fuel adaptation in the system is to correct for differences in the hardware of the components involved in the fuel injection and lambda control, such as injectors and lambda sensors. If the fuel adaptation shall handle both quality differences between gaseous fuels and hardware the risk of going outside the limits and getting an engine malfunction will be much higher.

A further drawback of the solution is that the effect of the gas quality on the air mass calculation will be completely ignored. Even though λ will be correct the amount of air calculated could be wrong. This affects the calculated torque and also the ignition angle used, which risks running the engine on an ignition angle which is not optimal and calculating an incorrect torque which could affect the drivability in a negative way.

There is thus a need for determining the specific gas constant and the stoichiometric air fuel ratio of a fuel gas for a gas engine in an advantageous way. This might then be used for adapting the control of the gas engine based on the determined specific gas constant and based on the determined stoichiometric air fuel ratio.

It is thus an object of the present invention to provide a method, a system, a vehicle, a computer program and a computer program product for an advantageous determination of the specific gas constant and based on the determined stoichiometric air fuel ratio.

It is further an object of the present invention to provide an alternative method, a system a vehicle, a computer program and a computer program product for determination of the specific gas constant and based on the determined stoichiometric air fuel ratio.

At least parts of the objects are achieved by a method for determining the specific gas constant and the stoichiometric air fuel ratio of a fuel gas for a gas engine. The method comprises the step of keeping the pressure essentially constant in an inlet manifold of the gas engine, so that the pressure is not varying more than a pre-determined threshold. The method further comprises the step of determining a first λ value downstream the gas engine while the engine is operated at a first time period of gas injection into the inlet manifold. The method comprises changing the first time period of gas injection into the inlet manifold into a second time period of gas injection into the inlet manifold and determining a second λ value downstream the gas engine after the changing of the time period of gas injection into the inlet manifold. The method further comprises the step of determining the specific gas constant and the stoichiometric air fuel ratio of the fuel gas based on the determined first and second λ value.

This method presents a way of determining the specific gas constant and the stoichiometric air fuel ratio of the fuel gas. It has the advantage that it can be performed in most existing vehicles without the need of additional components. The method can thus be employed as software updates to ECU of vehicles. It is thus cost-efficient to implement the method. Especially no sensors for analysing the gas composition are needed.

In one example the method comprises the step of determining at least one out of a temperature value in the inlet manifold of the gas engine and a pressure value in the inlet manifold of the gas engine. The determining of the specific gas constant and the stoichiometric air fuel ratio of the fuel gas is then based on the at least one out of the determined temperature value in the inlet manifold of the gas engine and the determined pressure value in the inlet manifold of the gas engine. Sensors for determining temperature and/or pressure in the inlet manifold are often present at nowadays vehicles. It also provides a way of determining the specific gas constant and the stoichiometric air fuel ratio of a fuel gas for a gas engine with relatively low computational complexity.

In one example the method further comprises the step of determining a flow of air into the gas engine and/or determining a mass of air in a cylinder of the gas engine. The determining of the specific gas constant and the stoichiometric air fuel ratio is then based on the determined flow of air into the gas engine and/or the determined mass of air in the cylinder of the gas engine. Sensors for determining a flow of air into the gas engine and/or determining a mass of air in a cylinder of the gas engine are often present at nowadays vehicles. It also provides a way of determining the specific gas constant and the stoichiometric air fuel ratio of a fuel gas for a gas engine with relatively low computational complexity.

In one example the method is performed while the load on the gas engine is essentially constant, so that the load on the gas engine is not varying more than a pre-determined threshold. This provides a way of using fewer variables when determining the specific gas constant and the stoichiometric air fuel ratio of a fuel gas for a gas engine. Having fewer variables lowers the sources of errors. Further, keeping the load constant makes it easier to control the pressure in the inlet manifold, thus lowering the complexity when implementing the method.

In one example the method is performed repeatedly and a resulting specific gas constant and/or a resulting stoichiometric air fuel ratio is calculated based on the repeatedly determined specific gas constants and/or the repeatedly determined air fuel ratios. This increases the accuracy of the specific gas constant and/or the air fuel ratio.

At least parts of the objects are achieved by a system for determining the specific gas constant and the stoichiometric air fuel ratio of a fuel gas for a gas engine. The system comprises means for keeping the pressure essentially constant in an inlet manifold of the gas engine, so that the pressure is not varying more than a pre-determined threshold. The system further comprises means for determining a first λ value downstream the gas engine while the engine is operated at a first time period of gas injection into the inlet manifold and means for changing the first time period of gas injection into the inlet manifold into a second time period of gas injection into the inlet manifold. The system even further comprises means for determining a second λ value downstream the gas engine after the changing of the time period of gas injection into the inlet manifold. The system also comprises means for determining the specific gas constant and the stoichiometric air fuel ratio of the fuel gas based on the determined first and second λ value.

In one embodiment the system comprises means for determining at least one out of a temperature value in the inlet manifold of the gas engine and a pressure value in the inlet manifold of the gas engine. The means for determining the specific gas constant and the stoichiometric air fuel ratio of the fuel gas is then arranged for basing the determining on the at least one out of the determined temperature value in the inlet manifold of the gas engine and the determined pressure value in the inlet manifold of the gas engine.

In one example the system further comprises means for determining a flow of air into the gas engine and/or determining a mass of air in a cylinder of the gas engine. The means for determining the specific gas constant and the stoichiometric air fuel ratio is then arranged for basing the determining on the determined flow of air into the gas engine and/or the determined mass of air in the cylinder of the gas engine.

In one embodiment the system further comprises means for performing the determining of the specific gas constant and the stoichiometric air fuel ratio of the fuel gas for the gas engine while the load on the gas engine is essentially constant, so that the load on the gas engine is not varying more than a pre-determined threshold.

In one embodiment the system further comprises means for determining a resulting stoichiometric air fuel ratio and/or a resulting stoichiometric air fuel ratio, wherein the means for determining a resulting stoichiometric air fuel ratio and/or a resulting stoichiometric air fuel ratio are arranged for determining the resulting specific gas constant and/or the resulting stoichiometric air fuel ratio based on repeatedly determined specific gas constants and/or repeatedly determined air fuel ratios.

At least parts of the objects are achieved by a vehicle comprising a system for determining the specific gas constant and the stoichiometric air fuel ratio of a fuel gas for a gas engine according to the present invention.

At least parts of the objects are achieved by a computer program for determining the specific gas constant and the stoichiometric air fuel ratio of a fuel gas for a gas engine. The computer program comprises program code for causing an electronic control unit or a computer connected to the electronic control unit to perform the steps of the method for determining the specific gas constant and the stoichiometric air fuel ratio of a fuel gas for a gas engine according to the present invention.

At least parts of the objects are achieved by a computer program product containing a program code stored on a computer-readable medium for performing the method steps of the method for determining the specific gas constant and the stoichiometric air fuel ratio of a fuel gas for a gas engine according to the present invention. The computer program is run on an electronic control unit or a computer connected to the electronic control unit.

The system, the vehicle, the computer program and the computer program product have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, a system according to one embodiment of the present invention;

FIG. 3 shows, in a schematic way, a flow chart over an example of a method according to the present invention; and

FIG. 4 shows, in a schematic way, a device which can be used in connection with the present invention.

### DETAILED DESCRIPTION OF THE INVENTION

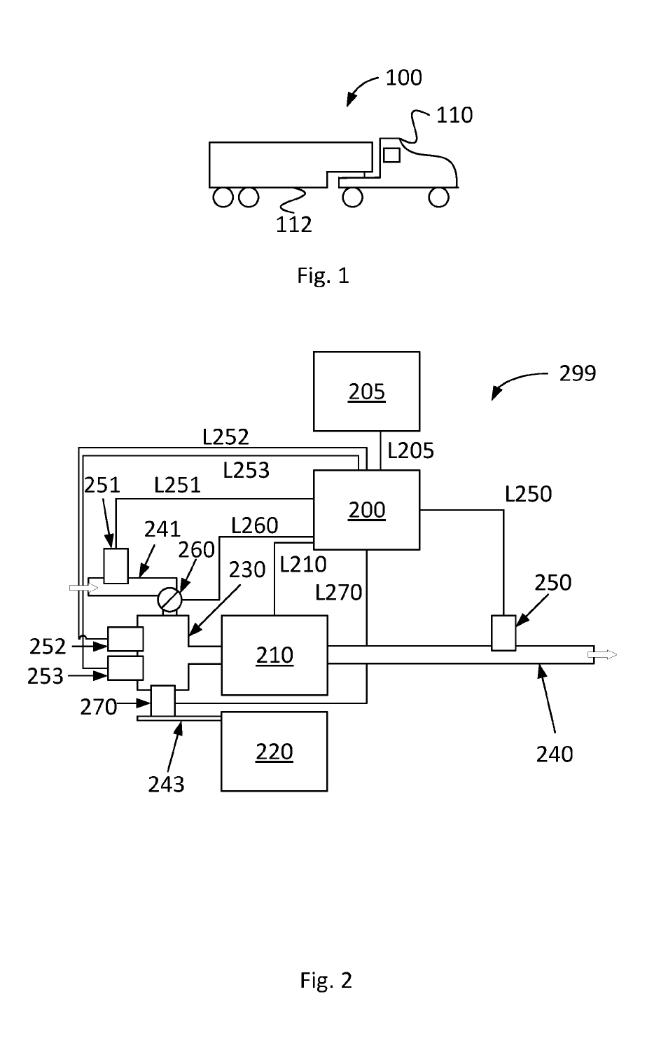

FIG. 1 shows a side view of a vehicle 100. In the shown example, the vehicle comprises a tractor unit 110 and a trailer unit 112. The vehicle 100 can be a heavy vehicle such as a truck. In one example, no trailer unit is connected to the vehicle 100. The vehicle 100 comprises a gas engine. The vehicle 100 comprises a system 299, se FIG. 2a. The system 299 can be arranged in the tractor unit 110.

In one example, the vehicle 100 is a bus. The vehicle 100 can be any kind of vehicle comprising a gas engine. Other examples of vehicles comprising a gas engine are boats, passenger cars, construction vehicles, and locomotives. The present invention can also be used in connection with any other platform than vehicles, as long as such a platform comprises a gas engine. One example is a power plant with a gas engine.

The innovative method and the innovative system according to one aspect of the invention are also well suited to, for example, systems which comprise industrial engines and/or engine-powered industrial robots.

Although in the following mainly described in connection with engines being operated at a stoichiometric AFR, the present invention is also suitable for engines operated at a lean AFR.

The term “link” refers herein to a communication link which may be a physical connection such as an opto-electronic communication line, or a non-physical connection such as a wireless connection, e.g. a radio link or microwave link.

FIG. 2 shows schematically an embodiment of a system 299 for determining the specific gas constant and the stoichiometric air fuel ratio of a fuel gas for a gas engine according to the present invention. The system 299 comprises a gas engine 210. The gas engine 210 can be arranged to propel a vehicle. The gas engine 210 comprises at least one cylinder. Each cylinder has a corresponding volume of the cylinder, V_{cyl}. In the following it is assumed that the volumes of the cylinders are equal. However, it should be understood that the present invention easily could be adapted to cylinders of different volumes by defining different volumes V_{cyl}_{_}ₙ for a specific cylinder n. The value V_{cyl} relates to a volume in the cylinder in which air and/or fuel can be injected at a pre-determined position of a piston in the cylinder. In one example, the value V_{cyl} relates to the maximum possible volume of the cylinder, for example when the position of the piston is in its least extended position. The value V_{cyl} is pre-determined for a given gas engine and can be stored in a first control unit 200.

Said first control unit 200 is arranged to control operation of said gas engine 210. Said first control unit 200 is arranged for communication with said gas engine 210 via a link L210. Said first control unit 200 is arranged to receive information from said gas engine 210.

Said system 299 comprises an air inlet 241. The possible flowing direction of air into the air inlet is indicated by the white arrow. The air then passes a throttle 260 before entering an inlet manifold 230. Said throttle 260 is arranged for controlling the flow of air into said inlet manifold 230. Said throttle 260 is, for example, controlled by said first control unit 200.

Said first control unit 200 is arranged to control operation of said throttle 260. Said first control unit 200 is arranged for communication with said throttle 260 via a link L260. Said first control unit 200 is arranged to receive information from said throttle 260.

Said system 299 further comprises a tank 220. Said tank 220 is arranged for storing the fuel gas of the vehicle. The fuel gas can, for example, be compressed natural gas, CNG. It should, however, be noted that the invention is not limited to CNG but could use any suitable gas which can act as a fuel gas for the gas engine 210. The tank 220 is connected via connecting means 243 to a gas injector arrangement 270. Said connecting means 243 can comprise pipes, tubes, or the like. Said connecting means 243 are arranged for transporting the fuel gas from the tank 220 to the gas injector arrangement 270.

Said gas injector arrangement 270 is arranged for injecting gas from the connecting means 243 into the inlet manifold 230. The gas is injected during a time period tᵢₙⱼ per working cycle. Said gas injector arrangement 270 comprises at least one gas injector. Each of said at least one gas injectors has an effective cross-sectional area, A_{CD}, of its injector nozzle. A_{CD} can be stored in said first control unit 200.

Said first control unit 200 is arranged to control operation of said gas injector arrangement 270. Said first control unit 200 is arranged for communication with said gas injector arrangement 270 via a link L270. Said first control unit 200 can be arranged to receive information from said gas injector arrangement 270.

Said first control unit 200 can, for example, be arranged to control tᵢₙⱼ. In one example, tᵢₙⱼ is calculated by said first control unit 200. In one example, tᵢₙⱼ is measured at the gas injector 270. tᵢₙⱼ can be stored in said first control unit 200.

Said system 299 further comprises an exhaust pipe 240. Said exhaust pipe 240 is connected to the gas engine 210 and arranged to transport exhausts from the gas engine 210 into the environment as indicated by the white arrow. It should be understood that means for treating the exhaust (not shown) can be arranged along the exhaust pipe. Such means are for example catalytic means for exhaust treatment.

Said system 299 further comprises means for determining a λ value downstream the gas engine. Said means for determining a first λ value downstream the gas engine can comprise a lambda sensor arrangement 250. Said lambda sensor arrangement 250 is provided downstream said gas engine. Said lambda sensor arrangement 250 is provided at said exhaust pipe 240. Said lambda sensor arrangement 250 comprises at least one lambda sensor. Said lambda sensor arrangement 250 is arranged to perform a measurement of λ, i.e. the ratio between actual air-fuel ratio, AFR, and stoichiometric air-fuel ratio, AFRₛ.

Said first control unit 200 is arranged to control operation of said lambda sensor arrangement 250. Said first control unit 200 is arranged for communication with said lambda sensor arrangement 250 via a link L250. Said first control unit 200 can be arranged to receive information from said lambda sensor arrangement 250.

The system 299 is arranged to determine λ values at different times. The system is arranged to determine at least a first λ value, λ₁, and a second λ value, λ₂. The system is arranged to determine λ₂ at a different time than λ₁. The system is arranged to measure λ₁ in connection with a first time period, tᵢₙⱼ_{₁}, of gas injection and λ₂ at a second time period, tᵢₙⱼ_{₂}, of gas injection, wherein tᵢₙⱼ_{₁} and tᵢₙⱼ_{₂} have different lengths.

Said system 299 further comprises means for determining a temperature value in the inlet manifold 230 of the gas engine 210. Said means for determining a temperature value in the inlet manifold 230 of the gas engine 210 can comprise a temperature sensor arrangement 252. Said temperature sensor arrangement can comprise at least one temperature sensor. Said temperature sensor arrangement 252 is arranged at the inlet manifold 230. Said temperature sensor arrangement 252 is arranged to measure the temperature Tᵢₙ in the inlet manifold 230.

Said first control unit 200 is arranged to control operation of said temperature sensor arrangement 252. Said first control unit 200 is arranged for communication with said temperature sensor arrangement 252 via a link L252. Said first control unit 200 can be arranged to receive information from said temperature sensor arrangement 252.

Said system 299 further comprises means for determining a pressure value in the inlet manifold 230 of the gas engine 210. Said means for determining a pressure value in the inlet manifold 230 of the gas engine 210 can comprise a pressure sensor arrangement 253. Said pressure sensor arrangement 253 can comprise at least one pressure sensor. Said pressure sensor arrangement 253 is arranged at the inlet manifold 230. Said pressure sensor arrangement 253 is arranged to measure the pressure pᵢₙ in the inlet manifold 230.

Said first control unit 200 is arranged to control operation of said pressure sensor arrangement 253. Said first control unit 200 is arranged for communication with said pressure sensor arrangement 253 via a link L253. Said first control unit 200 can be arranged to receive information from said pressure sensor arrangement 253.

Said system 299 further comprises means for determining a flow of air into the gas engine and/or means for determining a mass of air in a cylinder of the gas engine.

In one example, said means for determining a flow of air into the gas engine and/or means for determining a mass of air in a cylinder of the gas engine comprise a mass air flow sensor arrangement, MAF-sensor arrangement, 251. Said MAF-sensor arrangement 251 can comprise a hot film air mass sensor, HFM-sensor. Said MAF-sensor arrangement 251 is arranged for measuring an air mass flow in the air inlet 241.

Said first control unit 200 is arranged to control operation of MAF-sensor arrangement 251. Said first control unit 200 is arranged for communication with said MAF-sensor arrangement 251 via a link L251. Said first control unit 200 can be arranged to receive information from said MAF-sensor arrangement 251.

In one example, said means for determining a flow of air into the gas engine and/or means for determining a mass of air in a cylinder of the gas engine comprise means for determining a flow through the throttle 260. Said means for determining a flow through the throttle 260 can, for example, comprise a pressure sensor at the air inlet 241 and a temperature sensor at the air inlet 241 (not shown). Said means for determining a flow through the throttle 260 can also comprise means for determining an effective area of the throttle. Said effective area relates to an effective area through which the air can flow from the air inlet 241 through the throttle. Said means for determining an effective area of the throttle can comprise a sensor for determining an angle of a throttle flap. The first control unit 200 can then be arranged to calculate the flow of air mass through the throttle based on the measurement results of at least one of said temperature sensor at the air inlet, said pressure sensor at the air inlet and said sensor for determining an angle of the throttle flap.

In one example, the mass of air in a cylinder of the gas engine, mₐᵢᵣ, can be determined by said first control unit 200. This can, for example, be done based on the determined angle of the throttle flap and/or based on measurement results from said MAF-sensor arrangement 251.

The first control unit 200 can also be arranged to determine a volumetric efficiency, VE, of the cylinder. The volumetric efficiency can be determined based on pᵢₙ and/or Tᵢₙ. In one example the volumetric efficiency is determined via the equation VE=mₐᵢᵣ*Tᵢₙ*Rₐᵢᵣ/(pᵢₙ*V_{cyl}), where Rₐᵢᵣ denotes the specific gas constant of air. In one example, the first control unit 200 is arranged to determine a first volumetric efficiency, VE₁, of the cylinder in connection with a first time period, tᵢₙⱼ_{₁}, of gas injection, and a second volumetric efficiency, VE₂, of the cylinder in connection with a second time period, tᵢₙⱼ_{₂}, of gas injection, wherein tᵢₙⱼ_{₁} and tᵢₙⱼ_{₂} have different lengths. Values for the volumetric efficiency might be stored in said first control unit 200.

The system 299 is further arranged for keeping the pressure in the inlet manifold 230 essentially constant. The term essentially constant refers to the fact that the pressure is not varying more than a pre-determined threshold. Such a pre-determined threshold can, for example, be 1%, 2%, 3%, 5%, 7%, 10% or 15%. The threshold can be chosen in such a way that consideration is given to control uncertainties in the throttle 260 or to measurement uncertainties in the MAF-sensor arrangement 251, the temperature sensor arrangement 252, the pressure sensor arrangement 253, or in any other sensor arrangements which might be present in the system 299. In one example the first control unit 200 keeps the pressure in the inlet manifold 230 constant by controlling the throttle 260, for example the angle of the throttle flap.

A change in the pressure in the inlet manifold 230 can be caused by changing the time period of gas injection. Changing the time period of gas injection will result in more or less fuel gas injected into the inlet manifold, where the increase or decrease in the amount of gas will higher or lower the pressure in the inlet manifold 230, respectively. By controlling the throttle 260 the effect of an increased or decreased amount of fuel gas in the inlet manifold 230 can be compensated with a lower or higher amount of air, respectively, which passes the throttle 230 so as to keep the resulting pressure in the inlet manifold 230 constant. The pressure sensor arrangement 253 can be used for checking any changes of the pressure in the inlet manifold 230. In another example, the pressure in the inlet manifold is controlled without the pressure sensor arrangement 253. This can, for example, be achieved by making a calculation of the pressure based on the time period of gas injection and the amount of air passing the throttle 260.

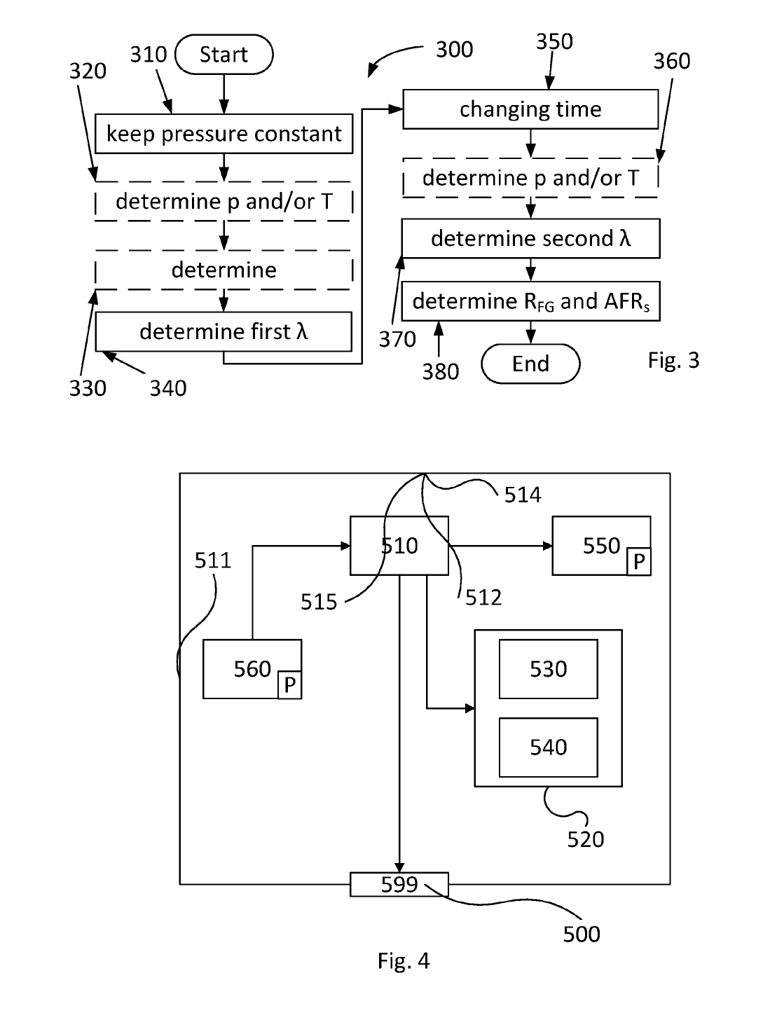

Said first control unit 200 is arranged for determining, during operation of the gas engine 210, the specific gas constant of a fuel gas for the gas engine 210. A way of doing this is described in relation to FIGS. 3 and 4.

Said first control unit 200 is arranged for determining the stoichiometric air fuel ratio of the fuel gas for the gas engine 210. A way of doing this is described in relation to FIGS. 3 and 4.

In one example, said first control unit 200 is arranged for adapting the control of the gas engine 210 based on the determined specific gas constant and the determined stoichiometric air fuel ratio. Said adapting the control of the gas engine 210 can comprise adapting the amount of fuel injected into the gas engine 210. This is in one example done by adapting tᵢₙⱼ. Said adapting the control of the gas engine 210 can comprise adapting the amount of air injected into the gas engine 210. This is in one example done by adapting the amount of air which can pass the throttle 260. This is in one example done by controlling the throttle flap. Said adapting the control of the gas engine 210 can comprise adapting the control of an exhaust gas recirculation, EGR (not shown). Said adapting the control of the gas engine 210 can comprise adapting a time of ignition in a cylinder of the gas engine 210. A person skilled in the art will realize that the control of a gas engine can relate to other parameters then those named here.

Adapting the control of the gas engine 210 based on the stoichiometric air fuel ratio and the specific gas constant of the fuel gas allows minimizing fuel consumption and emissions. It also allows increasing drivability of the gas engine 210. A further advantage of system 299 is that most or all of its components present in nowadays vehicles. The present invention can thus be applied to present vehicles via software updates, without the need of any new hardware arrangements.

It should also be understood that one or more of the measured parameters which are described in this application can instead be estimated or pre-determined. This is especially useful when the component of the system 299 which corresponds to measuring the parameter is not present at a present vehicle. Said estimation can, for example, be performed by said first control unit 200. Said estimation can, for example, be based on measurement results from the remaining sensors arrangement and/or a model of the fuel/air/engine system in the corresponding vehicle.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as adapting engine control of a gas engine in a vehicle. The innovative method may be conducted by the first control unit 200 or the second control unit 205, or by both of them.

In FIG. 3 a flowchart of an example of a method 300 for determining the specific gas constant and the stoichiometric air fuel ratio of a fuel gas for a gas engine is schematically illustrated. The method starts with step 310. It should be emphasized that the steps of the method 300 not necessarily have to be performed in the order at which they are presented. The order of the steps is only limited in so far as one step might need the result of another step as input. Where this is not the case, the steps might be performed in any order, or in parallel, as long as not explicitly stated otherwise.

In step 310 the pressure in an inlet manifold of the gas engine is kept essentially constant. The term essentially constant relates to the fact that the pressure is not varying more than a pre-determined threshold. The pre-determined threshold can be set as discussed in relation to FIG. 2. In general, the lower the threshold the better the more reliable the results for the specific gas constant and the stoichiometric air fuel ratio of the fuel gas will be. However, measurement uncertainties of sensors and controlling accuracy of the throttle usually give a reasonable lowest value of the threshold. The pre-determined threshold might thus be adapted to the specific components of the system 299 which is used for performing the method. The pressure in the inlet manifold is kept essentially constant at least while performing the steps 320, 330, 340, 360, 365, and 370. This means that said pressure in the inlet manifold is essentially the same while performing the steps 320, 330, 340, 360, 365, and 370.

The pressure can be kept constant by controlling the throttle 260. If a change in pressure would occur due to other reasons, the throttle can adapt the amount of air which is allowed to flow into the inlet manifold. This can then compensate for the change in pressure which otherwise would occur. Examples have been discussed in relation to FIG. 2. After step 310 an optional step 320 is performed.

In the optional step 320 at least one out of a temperature value in the inlet manifold of the gas engine and a pressure value in said inlet manifold of the gas engine are determined. Preferably the temperature value in the inlet manifold of the gas engine is determined. Preferably step 320 is performed before step 350. The determined temperature value in the inlet manifold of the gas engine from step 320 will in the following be denoted as a first temperature value Tᵢₙ_{₁}. The first temperature value can for example be determined by the temperature sensor arrangement 252. The first temperature value is determined during a first time period for the gas injection tᵢₙⱼ_{₁}. If a pressure value is determined this pressure value from step 320 will be denoted first pressure value pᵢₙ_{₁}. The first pressure value can for example be determined by the pressure sensor arrangement 253. The first pressure value is determined during a first time period for the gas injection tᵢₙⱼ_{₁}. In one example said first pressure and/or said first temperature value are determined without the help of the temperature sensor arrangement 252 and/or the pressure sensor arrangement 253. Said first temperature and/or said first pressure value can for example be determined by a model of the system 299 or parts thereof and other determined values. In one example, said other determined values comprise values determined by the MAF-sensor arrangement 241, by the throttle 260, and/or by the gas injector 270. After the optional step 320 an optional step 330 is performed.

In the optional step 330 a flow of air into the gas engine is determined and/or a mass of air in a cylinder of the gas engine is determined. In one example this is done based on measuring the mass air flow with the MAF-sensor arrangement 251. In one example this is done via determining the effective area of the throttle. This has been described in more detail above, in relation to FIG. 2. The mass of air in the cylinder of the gas engine determined in step 330 will in the following be determined as a first air mass, mₐᵢᵣ_{₁}. Preferably, the first air mass is determined during the first time period for the gas injection tᵢₙⱼ_{₁}. The method continues with step 340.

In step 340 a first λ value, λ₁, is determined downstream the gas engine. This can be done with the help of the lambda sensor arrangement 250. Said first λ value is determined during a time when the engine is operated with said first time period of gas injection. The method continues with step 350.

In step 350 the time period of gas injection into the inlet manifold is changed. This change implies preferably that the first time period of gas injection, tᵢₙⱼ_{₁}, is changed to a second time period of gas injection, tᵢₙⱼ_{₂}. Said changing can be an increase or a decrease relative to the first time period tᵢₙⱼ_{₁}. In one example, tᵢₙⱼ_{₂} is increased or decreased by 5% in relation to tᵢₙⱼ_{₁}. Said change in tᵢₙⱼ implies usually a change in pᵢₙ. Since, however, step 310 demands that the pressure in the inlet manifold is kept constant, this change in pᵢₙ has to be avoided. This is described in more detail in relation to step 310. After step 350 an optional step 360 is performed.

In the optional step 360 at least one out of a temperature value in the inlet manifold of the gas engine and a pressure value in said inlet manifold of the gas engine are determined. Preferably the temperature value in the inlet manifold of the gas engine is determined. The determined temperature value in the inlet manifold of the gas engine from step 360 will in the following be denoted as a second temperature value Tᵢₙ_{₂}. The second temperature value can for example be determined by the temperature sensor arrangement 252. The second temperature value is determined during a time while the engine is operated with the second time period for the gas injection tᵢₙⱼ_{₂}. If a pressure value is determined this pressure value from step 360 will be denoted second pressure value pᵢₙ_{₂}. The second pressure value can for example be determined by the pressure sensor arrangement 253. The second pressure value is determined during a time while the engine is operated with the second time period for the gas injection tᵢₙⱼ_{₂}. After the optional step 360 an optional step 365 is performed.

In the optional step 365 (not shown in FIG. 3) a flow of air into the gas engine is determined and/or a mass of air in a cylinder of the gas engine is determined. This is done in the same way as described in relation to step 330. The mass of air in the cylinder of the gas engine determined in step 365 will in the following be determined as a second air mass, mₐᵢᵣ_{₂}. Preferably, the second air mass is determined during the second time period for the gas injection tᵢₙⱼ_{₂}. The method continues with step 370.

In step 370 a second λ value, λ₂, is determined downstream the gas engine. This can be done with the help of the lambda sensor arrangement 250. Said second λ value is determined during a time while the engine is operated with said second time period of gas injection. The method continues with step 380.

In step 380 the specific gas constant of the fuel gas, R_{FG}, and the stoichiometric air fuel ratio of the fuel gas, AFRₛ, are determined based on said determined first and second λ value, λ₁ and λ₂. In one example said determination of R_{FG} and AFRₛ is based on a determined temperature value in the inlet manifold of the gas engine and/or a determined pressure value in said inlet manifold of the gas engine. In one example said determination of R_{FG} and AFRₛ is based on said first and second temperature value, Tᵢₙ_{₁} and Tᵢₙ_{₂}. In one example said determination of R_{FG} and AFRₛ is based on said determined flow of air into the gas engine and/or said determined mass of air in the cylinder of the gas engine, mₐᵢᵣ.

As an example, one can first determine a ratio of R_{FG} and AFRₛ according to the following equation:

$$\frac{{R}_{FG}}{{AFR}_{S}} = \frac{1 - \frac{{VE}_{1}}{{VE}_{2}}}{\frac{{VE}_{1}}{{VE}_{2} {λ}_{2}} - \frac{1}{{λ}_{1}}} {R}_{air} .$$

It should be noted that the first and second volumetric efficiencies only appear as a ratio in the above equation. It is therefore not necessary to determine the volumetric efficiencies themselves. Instead the ratio VE₁/VE₂ can be determined as (mₐᵢᵣ_{₁}*Tᵢₙ_{₁})/(mₐᵢᵣ_{₂}*Tᵢₙ_{₂})

A so-called Wobbe index W_{O} can be defined for the fuel gas according to the equation

$${W}_{{O}_{FG}} = {k}_{1} \frac{{AFR}_{s}}{\sqrt{{R}_{FG} \cdot {R}_{air}}} ,$$

where k₁ is a constant which can be empirically determined and which is essentially the same for all relevant fuel gases. For each gas engine a reference Wobbe index, W_{O}_{_{ref}}, can be defined for an arbitrary reference gas. This reference gas will then have a certain reference time period of gas injection, tᵢₙⱼ_{_{ref}}, for which a λ value of 1 will be achieved downstream the gas engine. The time period of gas injection for the actual fuel gas to achieve a λ value of 1 downstream the gas engine is denoted tᵢₙⱼ_{_{FG}}. These two time periods are related via the relation tᵢₙⱼ_{_{FG}}=k_{FG}*tᵢₙⱼ_{_{ref}}, wherein the constant k_{FG} can be denoted fuel factor.

In one example, the first control unit 200 is arranged to determine tᵢₙⱼ_{_{FG}}. This can be done by waiting until a λ value of 1 is reached during propulsion of the vehicle. The fuel factor k_{FG} can then be stored in the first control unit 200. tᵢₙⱼ_{_{ref}} can be determined based on AFRₛ_{_{ref}}, the specific gas constant for the reference gas, R_{ref}, and mₐᵢᵣ. From k_{FG} it is then possible to determine tᵢₙⱼ_{_{FG}}. The determination of tᵢₙⱼ_{_{FG}} can be done before the method 300 is started. In one example, the system 299 is actively controlled to reach a λ value of 1 so as to determine tᵢₙⱼ_{_{FG}}. R_{ref} and/or AFRₛ_{_{ref}} can be pre-determined and stored in the first control unit 200. From this the fuel factor can be determined.

The fuel factor relates also to the Wobbe index of the fuel gas and the reference gas via W_{O}_{_{FG}}=k_{FG}*W_{O}_{_{ref}}. The Wobbe index for the reference can be pre-determined and stored in the first control unit 200. From this the Wobbe index for the fuel gas can be determined.

Having determined the Wobbe index for the fuel gas and the ratio of R_{FG} and AFRₛ, the specific gas constant can then be determined via the equation

$${R}_{FG} = {( \frac{{W}_{{O}_{FG}} * \frac{{R}_{FG}}{{AFR}_{s}}}{\sqrt{{R}_{air}} * {k}_{1}} )}^{2} \cdot$$

From the determined R_{FG} and the determined ratio of R_{FG} and AFRₛ the stoichiometric air fuel ratio of the fuel gas can be determined.

It should be understood that the above equations are only an enabling example of how step 380 can be implemented. This example is not intended to limit the claims as there are different ways to determine R_{FG} and AFRₛ. As an example, it is not necessary to achieve a λ value of 1 with the fuel gas so as to determine tᵢₙⱼ_{_{FG}}. Any other λ value for tᵢₙⱼ will work as well. This will introduce further correction terms in the subsequent calculations, but one can arrive at R_{FG} and AFRₛ as well. It is neither necessary to perform all the above calculations. In one example, the above calculations are combined to final equations for R_{FG} and AFRₛ. In one example, step 380 is performed by the first control unit 200. After step 380 the method 300 ends.

In one example method 300 can be used as a step in a method for adapting the control of the gas engine. In this case the specific gas constant and the stoichiometric air fuel ratio of a fuel gas for a gas engine are first determined according to method 300. Afterwards the control of the gas engine is adapted based on the determined specific gas constant and based on the determined stoichiometric air fuel ratio.

Said adaption of the control of the gas engine comprises in one example adapting the amount of fuel injected into the gas engine. Said adapting of the control of the gas engine comprises in one example adapting tᵢₙⱼ. Said adapting of the control of the gas engine comprises in one example adapting the amount of air injected into the gas engine. This is in one example done by controlling the throttle flap. Said adapting of the control of the gas engine can comprise adapting the control of an exhaust gas recirculation, EGR. Said adapting the control of the gas engine can comprise adapting a time of ignition in a cylinder of the gas engine. Depending on the design of the gas engine there are other parameters as well which can be adapted. A person skilled in the art will be aware of which other parameters are present at a specific gas engine. Some advantages of the adaptions based on AFRₛ and R_{FG} are lower fuel consumption and/or lower amount of certain exhausts from the gas engine. If the optional step 390 is performed

In one example, the method 300 is performed while the load on the gas engine is essentially constant, so that the load on the gas engine is not varying more than a pre-determined threshold. The load is preferably at least essentially constant while performing steps 320, 330, 340, 360, 365, and 370. This has the advantage that no corrections for different loads of the engine have to be introduced in the equations used in connection with step 380. In one example, said load is essentially constant during 1, 2, 3, 5, 7, or 10 seconds. This is in one example the case when a driver of the vehicle is not accelerating with the vehicle. This is in one example the case when the vehicle is driving with constant speed. In another example this is the case when the driver is standing still with the vehicle, for example due to traffic lights. In general, situations with constant load will naturally appear during operation of the vehicle. Performing the method 300 as these situations naturally appear has the advantage of not affecting the driveability of the vehicle while the method 300 is performed. In an alternative example, the gas engine 210 and/or other components in the system 299 can be actively controlled so as to keep the load of the gas engine constant.

In one example, the method 300 is performed repeatedly. Thus AFRₛ and R_{FG} are determined repeatedly. A resulting specific gas constant and/or a resulting stoichiometric air fuel ratio is then calculated based on the repeatedly determined specific gas constants and/or the repeatedly determined air fuel ratios. This calculation is in one example an arithmetic mean of the repeatedly determined specific gas constants and/or the repeatedly determined air fuel ratios. In one example the repeatedly determined specific gas constants and/or the repeatedly determined air fuel ratios are weighted when calculating the resulting specific gas constant and/or the resulting stoichiometric air fuel ratio. The weighting can be based on how accurate each determined air fuel ratio and/or specific gas constant is. The accurateness relates in one example to errors or uncertainties in the lambda sensor arrangement 250, the MAF-sensor arrangement 251, the temperature sensor arrangement 252, the pressure sensor arrangement 253, the throttle 260, or the gas injector 270. In one example the accurateness relates to how well the pressure in the inlet manifold 230 and/or the load of the gas engine 210 can be kept constant. Performing the method 300 repeatedly results in higher accuracy of AFRₛ and R_{FG}.

The method 300 can also be combined with the method disclosed in the Swedish patent application 1650386-4, entitled “A method and a system for adapting engine control of a gas engine in a vehicle” (same applicant and filing date as the present patent application), to increase accuracy.

The inventive method 300, and embodiments thereof, as described above, may at least in part be performed with/using/by at least one device. The inventive method 300, and embodiments thereof, as described above, may be performed at least in part with/using/by at least one device that is suitable and/or adapted for performing at least parts of the inventive method 300 and/or embodiments thereof. A device that is suitable and/or adapted for performing at least parts of the inventive method 300 and/or embodiments thereof may be one, or several, of a control unit, an electronic control unit (ECU), an electronic circuit, a computer, a computing unit and/or a processing unit.

With reference to the above, the inventive method 300, and embodiments thereof, as described above, may be referred to as an, at least in part, computerised method. Said method 300 being, at least in part, computerised meaning that it is performed at least in part with/using/by said at least one device that is suitable and/or adapted for performing at least parts of the inventive method 300 and/or embodiments thereof.

With reference to the above, the inventive method 300, and embodiments thereof, as described above, may be referred to as an, at least in part, automated method. Said method 300 being, at least in part, automated meaning that it is performed with/using/by said at least one device that is suitable and/or adapted for performing at least parts of the inventive method 300 and/or embodiments thereof.

As described above, the inventive method 300, and embodiments thereof, as described above, may at least in part be performed with at least one means/unit/device. The inventive method 300, and embodiments thereof, as described above, may at least in part be performed with at least two separate means/unit/devices. These means/units/devices may, however, be at least to some extent logically separated by but implemented in the same physical unit/device. These means/units/devices may also be part of a single logic unit which is implemented in at least two different physical units/devices. These means/units/devices may also be at least to some extent logically separated and implemented in at least two different physical means/units/devices. Further, these units/devices may be both logically and physically arranged together, i.e. be part of a single logic unit which is implemented in a single physical means/unit/device. These means/units/devices may for example correspond to groups of instructions, which can be in the form of programming code, that are input into, and are utilized by at least one processor when the units are active and/or are utilized for performing its method step, respectively. It should be noted that the system 299 may be implemented at least partly within the vehicle 100 and/or at least partly outside of the vehicle 100, e.g. in a server, computer, processor or the like located separately from the vehicle 100.

FIG. 4 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program comprises routines for determining the specific gas constant and the stoichiometric air fuel ratio of a fuel gas for a gas engine.

The computer program P may comprise routines for keeping the pressure essentially constant in an inlet manifold of the gas engine, so that the pressure is not varying more than a pre-determined threshold. This may at least partly be performed by means of said first control unit 200 controlling operation of the throttle 260.

The computer program P may comprise routines for determining a first λ value downstream the gas engine. This may at least partly be performed by means of said first control unit 200 controlling operation of the lambda sensor arrangement 250. Said first λ value may be stored in said non-volatile memory 520.

The computer program P may comprise routines for changing the time period of gas injection into the inlet manifold. This may at least partly be performed by means of said first control unit 200 controlling operation of said gas injector 270.

The computer program P may comprise routines for determining a second λ value downstream the gas engine after said changing of the time period of gas injection into the inlet manifold. This may at least partly be performed by means of said first control unit 200 controlling operation of the lambda sensor arrangement 250. Said second λ value may be stored in said non-volatile memory 520.

The computer program P may comprise routines for determining the specific gas constant and the stoichiometric air fuel ratio of the fuel gas based on said determined first and second λ value.

The computer program P may comprise routines for determining at least one out of a temperature value in the inlet manifold of the gas engine and a pressure value in said inlet manifold of the gas engine. This may at least partly be performed by means of said first control unit 200 controlling operation of the temperature sensor arrangement 252 and/or the pressure sensor arrangement 253. Said temperature value and/or pressure value may be stored in said non-volatile memory 520.

The computer program P may comprise routines for determining a flow of air into the gas engine and/or determining a mass of air in a cylinder of the gas engine. This may at least partly be performed by means of said first control unit 200 controlling operation of any of the mass air flow sensor arrangement 251, and/or the throttle 260. The result of said determined flow of air into the gas engine and/or the determined mass of air in a cylinder of the gas engine may be stored in said non-volatile memory 520.

The computer program P may comprise routines for determining the specific gas constant and the stoichiometric air fuel ratio of the fuel gas for the gas engine repeatedly. The repeatedly determined specific gas constants and the repeatedly determined stoichiometric air fuel ratios of the fuel gas for the gas engine may be stored in said non-volatile memory. The computer program P may comprise routines for determining a resulting specific gas constant and/or a resulting stoichiometric air fuel ratio based on the repeatedly determined specific gas constant and/or the repeatedly determined air fuel ratio.

The computer program P may comprise routines for determining a flow of air into the gas engine 210 and/or for determining a mass of air in a cylinder of the gas engine 210.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L210, L250-255, and L270, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

1. A method for determining a specific gas constant and a stoichiometric air fuel ratio of a fuel gas for a gas engine, the method comprising:
keeping a pressure essentially constant in an inlet manifold of the gas engine, so that the pressure is not varying more than a pre-determined threshold;
determining a first λ value downstream the gas engine while the engine is operated at a first time period of gas injection into the inlet manifold;
changing said first time period of gas injection into the inlet manifold to a second time period of gas injection into the inlet manifold;
determining a second λ value downstream the gas engine after said changing of the time period of gas injection into the inlet manifold; and
determining the specific gas constant and the stoichiometric air fuel ratio of the fuel gas based on said determined first and second λ value.

2. The method according to claim 1, further comprising:
determining at least one of a temperature value in the inlet manifold of the gas engine and/or a pressure value in said inlet manifold of the gas engine,
wherein said determining of the specific gas constant and the stoichiometric air fuel ratio of the fuel gas is based on said at least one of the determined temperature value in the inlet manifold of the gas engine and/or the determined pressure value in said inlet manifold of the gas engine.

3. The method according to claim 1, further comprising:
determining a flow of air into the gas engine and/or determining a mass of air in a cylinder of the gas engine,
wherein said determining of the specific gas constant and the stoichiometric air fuel ratio is based on said determined flow of air into the gas engine and/or said determined mass of air in the cylinder of the gas engine.

4. The method according to claim 1, wherein the method is performed while a load on the gas engine is essentially constant, so that the load on the gas engine is not varying more than a pre-determined threshold.

5. The method according to claim 1, wherein the method is performed repeatedly and a resulting specific gas constant and/or a resulting stoichiometric air fuel ratio is calculated based on the repeatedly determined specific gas constants and/or the repeatedly determined air fuel ratios.

6. A system for determining a specific gas constant and a stoichiometric air fuel ratio of a fuel gas for a gas engine, the system comprising:
means for keeping a pressure essentially constant in an inlet manifold of the gas engine, so that the pressure is not varying more than a pre-determined threshold;
means for determining a first λ value downstream the gas engine while the engine is operated at a first time period of gas injection into the inlet manifold;
means for changing said first time period of gas injection into the inlet manifold to a second time period of gas injection into the inlet manifold;
means for determining a second λ value downstream the gas engine after said changing of the time period of gas injection into the inlet manifold; and
means for determining the specific gas constant and the stoichiometric air fuel ratio of the fuel gas based on said determined first and second λ value.

7. The system according to claim 6, further comprising:
means for determining at least one of a temperature value in the inlet manifold of the gas engine and/or a pressure value in said inlet manifold of the gas engine,
wherein said means for determining the specific gas constant and the stoichiometric air fuel ratio of the fuel gas is arranged for basing said determining on said at least one of the determined temperature value in the inlet manifold of the gas engine and/or the determined pressure value in said inlet manifold of the gas engine.

8. The system according to claim 6, further comprising:
means for determining a flow of air into the gas engine and/or determining a mass of air in a cylinder of the gas engine,
wherein said means for determining the specific gas constant and the stoichiometric air fuel ratio is arranged for basing said determining on said determined flow of air into the gas engine and/or said determined mass of air in the cylinder of the gas engine.

9. The system according to claim 6, further comprising means for performing the determining of the specific gas constant and the stoichiometric air fuel ratio of the fuel gas for the gas engine while a load on the gas engine is essentially constant, so that the load on the gas engine is not varying more than a pre-determined threshold.

10. The system according to claim 6, further comprising means for determining a resulting stoichiometric air fuel ratio and/or a resulting stoichiometric air fuel ratio, wherein said means for determining a resulting stoichiometric air fuel ratio and/or a resulting stoichiometric air fuel ratio are arranged for determining the resulting specific gas constant and/or the resulting stoichiometric air fuel ratio based on repeatedly determined specific gas constants and/or repeatedly determined air fuel ratios.

11. A vehicle comprising a system for determining a specific gas constant and a stoichiometric air fuel ratio of a fuel gas for a gas engine, the system comprising:
means for keeping a pressure essentially constant in an inlet manifold of the gas engine, so that the pressure is not varying more than a pre-determined threshold;
means for determining a first λ value downstream the gas engine while the engine is operated at a first time period of gas injection into the inlet manifold;
means for changing said first time period of gas injection into the inlet manifold to a second time period of gas injection into the inlet manifold;
means for determining a second λ value downstream the gas engine after said changing of the time period of gas injection into the inlet manifold; and
means for determining the specific gas constant and the stoichiometric air fuel ratio of the fuel gas based on said determined first and second λ value.

12. (canceled)

13. (canceled)

14. The system according to claim 11, further comprising:
means for determining at least one of a temperature value in the inlet manifold of the gas engine and/or a pressure value in said inlet manifold of the gas engine,
wherein said means for determining the specific gas constant and the stoichiometric air fuel ratio of the fuel gas is arranged for basing said determining on said at least one of the determined temperature value in the inlet manifold of the gas engine and/or the determined pressure value in said inlet manifold of the gas engine.

15. The system according to claim 11, further comprising:
means for determining a flow of air into the gas engine and/or determining a mass of air in a cylinder of the gas engine,
wherein said means for determining the specific gas constant and the stoichiometric air fuel ratio is arranged for basing said determining on said determined flow of air into the gas engine and/or said determined mass of air in the cylinder of the gas engine.

16. The system according to claim 11, further comprising means for performing the determining of the specific gas constant and the stoichiometric air fuel ratio of the fuel gas for the gas engine while a load on the gas engine is essentially constant, so that the load on the gas engine is not varying more than a pre-determined threshold.

17. The system according to claim 11, further comprising means for determining a resulting stoichiometric air fuel ratio and/or a resulting stoichiometric air fuel ratio, wherein said means for determining a resulting stoichiometric air fuel ratio and/or a resulting stoichiometric air fuel ratio are arranged for determining the resulting specific gas constant and/or the resulting stoichiometric air fuel ratio based on repeatedly determined specific gas constants and/or repeatedly determined air fuel ratios.

18. A computer program product comprising computer program code stored on a non-transitory computer-readable medium, said computer program product for determining a specific gas constant and a stoichiometric air fuel ratio of a fuel gas for a gas engine, said computer program product comprising computer instructions to cause said at least one control unit to perform the following operations:
keeping a pressure essentially constant in an inlet manifold of the gas engine, so that the pressure is not varying more than a pre-determined threshold;
determining a first λ value downstream the gas engine while the engine is operated at a first time period of gas injection into the inlet manifold;
changing said first time period of gas injection into the inlet manifold to a second time period of gas injection into the inlet manifold;
determining a second λ value downstream the gas engine after said changing of the time period of gas injection into the inlet manifold; and
determining the specific gas constant and the stoichiometric air fuel ratio of the fuel gas based on said determined first and second λ value.

19. The computer program product according to claim 18, further comprising computer instructions to cause said at least one control unit to perform the following operations:
determining at least one of a temperature value in the inlet manifold of the gas engine and/or a pressure value in said inlet manifold of the gas engine,
wherein said determining of the specific gas constant and the stoichiometric air fuel ratio of the fuel gas is based on said at least one of the determined temperature value in the inlet manifold of the gas engine and/or the determined pressure value in said inlet manifold of the gas engine.

20. The computer program product according to claim 18, further comprising computer instructions to cause said at least one control unit to perform the following operations:
determining a flow of air into the gas engine and/or determining a mass of air in a cylinder of the gas engine,
wherein said determining of the specific gas constant and the stoichiometric air fuel ratio is based on said determined flow of air into the gas engine and/or said determined mass of air in the cylinder of the gas engine.

21. The computer program product according to claim 18, wherein the operations are performed while a load on the gas engine is essentially constant, so that the load on the gas engine is not varying more than a pre-determined threshold.

22. The computer program product according to claim 18, wherein the operations are performed repeatedly and a resulting specific gas constant and/or a resulting stoichiometric air fuel ratio is calculated based on the repeatedly determined specific gas constants and/or the repeatedly determined air fuel ratios.
